(19) United States
(12) Patent Application Publication
(10) Pub. No.: US 2012/0146999 A1
(43) Pub. Date: Jun. 14, 2012

(54) PIXEL FOR DISPLAY DEVICE, DISPLAY DEVICE, AND DRIVING METHOD THEREOF

(75) Inventor: Young-In Hwang, Yongin-City (KR)

(73) Assignee: Samsung Mobile Display Co., Ltd., Yongin-City (KR)

(21) Appl. No.: 13/244,112

(22) Filed: Sep. 23, 2011

(30) Foreign Application Priority Data
Dec. 10, 2010 (KR) 10-2010-0126491

(51) Int. Cl. G09G 3/30; G06T 15/00; G09G 5/00

(52) U.S. Cl. 345/419; 345/76; 345/211; 345/204

(57) ABSTRACT

A pixel of a display device is disclosed. According to one aspect, the pixel includes an organic light emitting diode (OLED). The pixel further includes a data sustain unit configured to maintain a data signal input from a data line during light emission of the OLED, a driving current supply unit configured to receive the data signal from the data sustain unit to emit light from the OLED, and a relay transistor configured to insulate the data sustain unit and the driving current supply unit from each other during light emission by the OLED. A data signal input to the data sustain unit is transmitted to the driving current supply unit after the OLED emits the light. A driving speed at which data to display a stereoscopic image is input may be decreased, a luminance reduction by black data may be reduced, and power consumption may be reduced.

### CROSS-REFERENCE TO RELATED APPLICATIONS

This application claims priority to and the benefit of Korean Patent Application No. 10-2010-0126491 filed in the Korean Intellectual Property Office on Dec. 10, 2010, the entire contents of which are incorporated herein by reference.

### BACKGROUND

1. Field

The disclosed technology relates to a pixel for a display device, a display device using the same, and a driving method thereof. More particularly, the disclosed technology relates to a pixel capable of simultaneously executing data input and light emitting for a display device, a display device using the same, and a driving method thereof.

2. Description of the Related Technology

A stereoscopic image display device realizes a 3D stereoscopic effect seen by each eye from a 2D image by using binocular disparity. That is, the disparity of images seen by each eye increases as an observer becomes close to an object, and the disparity decreases as the observer becomes farther away from the object. For example, if left and right images on a screen are adjusted to correspond to each other, the viewer perceives that the object is on the screen. However if the left-eye image is located on the left side and the right-eye image is located on the right side, the viewer perceives that the object is located behind the screen. Alternatively, if the left-eye image is located on the right side and the right-eye image is located on the left side, the viewer perceives that the object is in front of the screen. As a result, depth perception of the object is determined by an interval between the right and left images that are located on the screen.

A conventional method of displaying a stereoscopic image is a method of dividing and selecting a left-eye image and a right-eye image that are displayed with a red color and a blue color. For example, color lenses using color filters that have a relationship of complementary colors are used to display the left-eye image and the right-eye image. Additionally, conventional methods of displaying a stereoscopic image include a method in which the left-eye image and the right-eye image are displayed through different polarization, such that the images are divided and selected by polarizing lenses. The conventional method of applying color lenses has a drawback in that the object is not displayed with a natural color. The conventional method of applying the polarizing lenses has a drawback that the left-eye image may be partially or wholly recognized through the right eye or the right-eye image may be partially or wholly recognized through the left eye according to a polarization capacity such that the stereoscopic effect is reduced.

The above-recited is only for enhancement of understanding of the background of the invention and therefore may contain information that does not form the prior art that is already known in this country to a person of ordinary skill in the art.

### SUMMARY OF CERTAIN INVENTIVE ASPECTS

According to some aspects, a pixel for a display device that is capable of decreasing driving speed of a stereoscopic image display device of a time-division type and increasing luminance of an image, a display device using the same, and a driving method thereof are disclosed.

According to one aspect, a pixel for a display device is disclosed. The pixel includes an organic light emitting diode (OLED), a data sustain unit configured to maintain a data signal input from a data line during light emission of the OLED, a driving current supply unit configured to receive the data signal from the data sustain unit to emit light from the OLED, and a relay transistor configured to insulate the data sustain unit and the driving current supply unit from each other during light emission by the OLED and transmit the data signal input to the data sustain unit to the driving current supply unit after the OLED emits the light.

According to another aspect, a display is disclosed. The display includes a display unit including a plurality of pixels, and a data driver configured to apply a first data signal to the display unit and apply a second data signal to the display unit for emitting light through the plurality of pixels by the first data signal. The plurality of pixels respectively include an organic light emitting diode (OLED), a driving current supply unit configured to the OLED to emit light, a data sustain unit configured to maintain the second data signal during light emission of the OLED by the first data signal, and a relay transistor configured to insulate the data sustain unit and the driving current supply unit from each other during the light emission of the OLED by the first data signal and transmit the second data signal maintained in the data sustain unit to the driving current supply unit after the OLED emits light by the first data signal.

According to another aspect, a method of driving a display device id disclosed. The method includes sequentially inputting a first data signal to a plurality of pixels, sequentially inputting a second data signal to the plurality of pixels while simultaneously emitting light from the plurality of pixels input with the first data, and sequentially inputting a third data signal to the plurality of pixels while simultaneously light emitting the plurality of pixels input with the second data signal.

In some embodiments, a driving speed at which data to display a stereoscopic image is input may be decreased, a luminance reduction by black data may be reduced, and power consumption may be reduced.

### BRIEF DESCRIPTION OF THE DRAWINGS

FIG. 1 is a block diagram of a display device according to some embodiments.

FIG. 2 is a circuit diagram of a pixel according to some embodiments.

FIG. 3 is a timing diagram of a driving method of a display device according to some embodiments.

FIG. 4 is a circuit diagram of a pixel according to some embodiments.

FIG. 5 is a timing diagram of a driving method of a display device according to some embodiments.

FIG. 6 is a view of a simultaneous input and light emitting method according to some embodiments.

FIG. 7 is a view showing one example of a method of providing an input after emitting light.

### DETAILED DESCRIPTION OF CERTAIN INVENTIVE EMBODIMENTS

Hereinafter, some embodiments are described in detail with reference to the accompanying drawings in order for those skilled in the art to be able to readily practice the exemplary embodiments. As those skilled in the art will realize, the described embodiments may be modified in various different ways, all without departing from the spirit or scope of the present invention.

Furthermore, in some embodiments, constituent elements having the same construction are assigned the same reference numerals and are described in connection with a first exemplary embodiment as a representative example. In the remaining embodiments, only constituent elements different from those of the first embodiment are described.

In order to clarify a description of the present invention, parts not related to the description are omitted, and the same reference numbers are used throughout the drawings to refer to the same or like parts.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

A display device according to some embodiments may be realized using various types of technologies such as liquid crystal display (LCD), field emission display (FED), plasma display panel (PDP), and organic light emitting diode (OLED) display. Hereafter, for better understanding and ease of description, the OLED display is described as one example of a display device. However the display device according to some embodiments is not limited thereto.

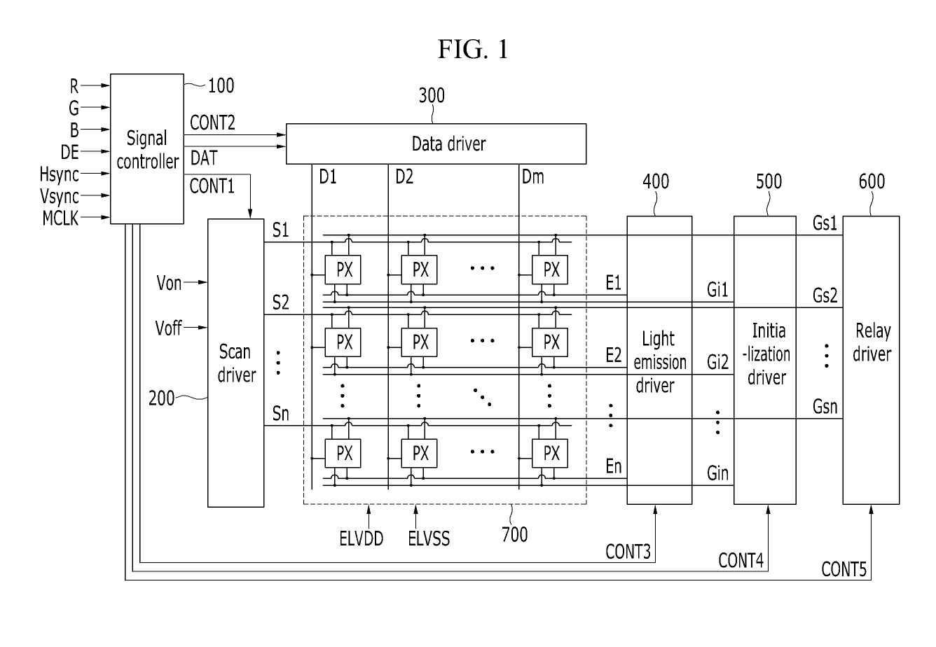

FIG. 1 is a block diagram of a display device according to some embodiments.

Referring to FIG. 1, a display device includes a display unit 700, a scan driver 200, a data driver 300, a light emission driver 400, an initialization driver 500, a relay driver 600 connected thereto, and a signal controller 100 controlling the drivers 200, 300, 400, 500, and 600.

The signal controller 100 receives video signals R, G, and B that are received as an input from an external device, and an input control signal that controls displaying the video signals. The video signals R, G, and B include luminance of each pixel PX, and the luminance has a grayscale having a predetermined number, for example, 1024=2¹⁰, 256=2⁸, or 64=2⁶. As examples of the input control signal, a vertical synchronization signal Vsync, a horizontal synchronization signal Hsync, a main clock signal MCLK, and a data enable signal DE may be provided.

The signal controller 100 appropriately processes the input video signals R, G, and B according to the operation condition of the display unit 700 and the data driver 300 on the basis of the input video signals R, G, and B and the input control signal. The signal controller 100 generates a scan control signal CONT1, a data control signal CONT2, a light emission control signal CONT3, an initialization control signal CONT4, a relay control signal CONT5, and an image data signal DAT. The signal controller 100 transmits the scan control signal CONT1 to the scan driver 200. The signal controller 100 transmits the data control signal CONT2 and the image data signal DAT to the data driver 300. The image data signal DAT includes a left eye image data signal and a right eye image data signal. The signal controller 100 transmits the light emission control signal CONT3 to the light emission driver 400. The signal controller 100 transmits the initialization control signal CONT4 to the initialization driver 500. The signal controller 100 also transmits the relay control signal CONT5 to the relay driver 600.

The display unit 700 includes a plurality of scan lines S1-Sn, a plurality of data lines D1-Dm, a plurality of light emitting lines E1-En, a plurality of initialization lines Gi1-Gin, a plurality of relay lines Gs1-Gsn, and a plurality of pixels PX connected to a plurality of signal lines S1-Sn, D1-Dm, Gi1-Gin, and Gs1-Gsn and arranged in an approximate matrix form. The plurality of scan lines S1-Sn are extended in a row direction and are formed parallel with each other, and the plurality of data lines D1-Dm are extended in a column direction and are formed parallel with each other. As illustrated in FIG. 1, the plurality of light emitting lines E1-En, the plurality of initialization lines Gi1-Gin, and the plurality of relay lines Gs1-Gsn are extended in the row direction corresponding to each of the scan lines S1-Sn. However, the plurality of light emitting lines E1-En, the plurality of initialization lines Gi1-Gin, and the plurality of relay lines Gs1-Gsn may be extended in an approximate column direction. The plurality of scan lines S1-Sn are connected to the scan driver 200. The plurality of data lines D1-Dm are connected to the data driver 300. The plurality of light emitting lines E1-En are connected to the light emission driver 400. The plurality of initialization lines Gi1-Gin are connected to the initialization driver 500. The plurality of relay lines Gs1-Gsn are connected to the relay driver 600. The plurality of pixels PX of the display unit 400 receive a first power source voltage ELVDD and a second power source voltage ELVSS from the outside.

The scan driver 200 is connected to the plurality of scan lines S1-Sn, and applies scan signals that include a combination of a gate-on voltage Von and a gate-off voltage Voff to the plurality of scan lines S1-Sn according to the scan control signal CONT1. The scan driver 200 applies the scan signal to the plurality of scan lines S1-Sn such that the data signal is applied to the plurality of pixels PX. The scan driver 200 applies the scan signal to the plurality of scan lines S1-Sn such that a first view-point image data and a second view-point image data are sequentially input to the plurality of pixels. The first-view point image data and the second view-point image data correspond to image data to display a stereoscopic image in a single frame.

The data driver 300 is connected to the plurality of data lines D1-Dm, and selects a data voltage according to the image data signal DAT. The data driver 300 applies the selected data voltage as the data signal to the plurality of data lines D1-Dm according to the data control signal CONT2. The data signal includes left eye image data to display the left-eye image and right-eye image data to display the right-eye image. That is, the data driver 300 applies the first view point image data and the second view point image data to the plurality of data lines D1-Dm. The data driver 300 temporally divides the first view point image data and the second view point image data and applies them to the plurality of data lines D1-Dm. The data driver 300 applies the second view point image data to the plurality of pixels during a period in which the plurality of pixels PX emit light corresponding to the first view point image data.

The light emission driver 400 is connected to a plurality of light emitting lines E1-En, and applies the light emitting signal that includes a combination of a gate-on voltage Von and a gate-off voltage Voff to the plurality of light emitting lines E1-En according to the light emission control signal CONT3. The light emission driver 400 applies the light emitting signal to the plurality of light emitting lines E1-En such that the plurality of pixels input with the first viewpoint image data or the second viewpoint image data simultaneously emit light. The light emission driver 400 may simultaneously apply the light emitting signals to the plurality of pixels.

The initialization driver 500 is connected to the plurality of initialization lines Gi1-Gin, and applies the initialization signal including the combination of the gate-on voltage and the gate-off voltage to the plurality of initialization lines Gi1-Gin according to the initialization control signal CONT4. The initialization driver 500 initializes the first viewpoint image data or the second viewpoint image data that is previously input to the plurality of pixels and applies the initialization signal to compensate the threshold voltage of the driving transistor of the pixels to the plurality of initialization lines Gi1-Gin. The light emission driver 400 may simultaneously apply the initialization signal to the plurality of pixels.

The relay driver 600 is connected to the plurality of relay lines Gs1-Gsn, and applies the relay signal including the combination of the gate-on voltage and the gate-off voltage to the plurality of relay lines Gs1-Gsn according to the relay control signal CONT5. The relay driver 600 allows the other of the first viewpoint image data or the other second viewpoint image data to be input to the plurality of pixels during the period in which the plurality of pixels emit light corresponding to the first viewpoint image data or the second viewpoint image data that is previously input. For example, relay driver 600 may allow the first viewpoint image data to be provided as an input during a period in which the plurality of pixels emit light corresponding to the second viewpoint image data which was previously input. The relay driver 600 applies the relay signal transmitting the other of the first viewpoint image data or the second viewpoint image data to the driving current supply unit for emitting light of the pixel to the plurality of relay lines Gs1-Gsn after the plurality of pixels emit the light corresponding to the first viewpoint image data or the second viewpoint image data that is previously input. The relay driver 600 may simultaneously apply the relay signal to the plurality of pixels.

The above-described driving devices 100, 200, 300, 400, 500, and 600 may be directly mounted on the display unit 300 in the form of at least one IC chip, may be mounted on a flexible printed circuit film (not shown) and then mounted on the display unit 300 in the form of a tape carrier package (TCP), or may be mounted on a separate printed circuit board (not shown). Further, the driving devices 100, 200, 300, 400, 500, and 600 may be integrated on the display unit 700 together with the signal lines S1-Sn, D1-Dm, Gi1-Gin, and Gs1-Gsn.

The display device according to the some embodiments may display the stereoscopic image by the time-division method. The method of temporally dividing the left-eye image and the right-eye image to display the stereoscopic image is referred to as a time-division method. Hereafter, the first viewpoint indicates one of left eye and right eye, and the second viewpoint indicates the other of left eye or right eye. The image for the first viewpoint is referred to as the first viewpoint image, and the image for the second viewpoint is referred to as the second viewpoint image. The data for the first viewpoint is referred to as the first viewpoint data, and the data for the second viewpoint is referred to as the second viewpoint data. One frame may correspond to a unit for dividing the images displayed in the stereoscopic image display device. In the time-division method, one frame of the stereoscopic image corresponds to a unit image of the stereoscopic image in which the left-eye image and the right-eye image are temporally divided and displayed on the entire screen. The left-eye image and the right-eye image that correspond to each other under one frame are recognized as the stereoscopic image to a viewer.

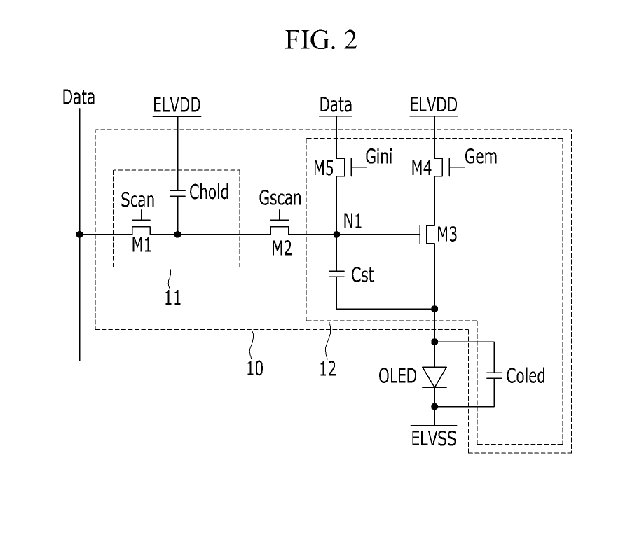

FIG. 2 is a circuit diagram of a pixel according to some embodiments.

Referring to FIG. 2, the pixel includes an organic light emitting diode OLED and a pixel circuit 10 to control the organic light emitting diode OLED.

The pixel circuit 10 includes a data sustain unit 11 configured to maintain the data signal Data input through the data line, a driving current supply unit 12 configured to receive the data signal Data from the data sustain unit 11 for emitting light through the organic light emitting diode OLED, and a relay transistor M2 configured to transmit the data signal Data input to the data sustain unit 11 to the driving current supply unit 12.

The sustain unit 11 includes a first sustain capacitor Chold configured to store the data signal Data, and a switching transistor M1 connected to the data line and configured to transmit the data signal Data to the first sustain capacitor Chold.

The switching transistor M1 includes a gate electrode connected to the scan line and applied with the scan signal Scan, one terminal connected to the data line, and the other terminal connected to the first sustain capacitor Chold.

The first sustain capacitor Chold includes one terminal connected to the first power source electrode ELVDD and the other terminal connected to the other terminal of the switching transistor M1.

The relay transistor M2 includes a gate electrode connected to the relay lines and applied with a relay signal Gscan, one terminal connected to the other terminal of the switching transistor M1, and the other terminal connected to a first node N1. The relay transistor M2 insulates the data sustain unit 11 and the driving current supply unit 12 from each other such that the data sustain unit 11 is input with the data signal Data while emitting light through the organic light emitting diode OLED. The relay transistor M2 transmits the data signal input to the data sustain unit 11 to the driving current supply unit 12 after emitting light during a predetermined light emitting period of the organic light emitting diode OLED.

The driving current supply unit 12 includes a second sustain capacitor Cst, a driving transistor M3, a light emitting transistor M4, an initialization transistor M5, and a third sustain capacitor Coled.

The second sustain capacitor Cst includes one terminal connected to the first node N1 and the other terminal connected to the other terminal of the driving transistor M3. The second sustain capacitor Cst stores the data signal transmitted from the data sustain unit 11. That is, the second sustain capacitor Cst receives and stores the data signal stored to the first sustain capacitor Chold.

The driving transistor M3 includes a gate electrode connected to the first node N1, one terminal connected to the first power source electrode, and the other terminal connected to the anode of the organic light emitting diode OLED. The driving transistor M3 transmits the current corresponding to the data signal stored to the second sustain capacitor Cst to the organic light emitting diode OLED.

The light emitting transistor M4 includes a gate electrode connected to the light emitting lines and applied with a light emitting signal Gem, one terminal connected to the first power source electrode, and the other terminal connected to one terminal of the driving transistor M3. The light emitting transistor M4 transmits the first power source electrode voltage ELVDD to one terminal of the driving transistor M3 such that the current corresponding to the data signal stored in the second sustain capacitor Cst flows through the driving transistor M3.

The initialization transistor M5 includes a gate electrode connected to the initialization lines and applied with an initialization signal Gini, one terminal connected to the data line, and the other terminal connected to the first node N1. The initialization transistor M5 transmits the initialization voltage to the gate electrode of the driving transistor when the data line is applied with a predetermined initialization voltage to initialize the organic light emitting diode OLED and to compensate the threshold voltage of the driving transistor M3.

The third sustain capacitor Coled includes one terminal connected to the anode of the organic light emitting diode OLED and the other terminal connected to the cathode of the organic light emitting diode OLED. The third sustain capacitor Coled may be a parasitic capacitor. The third sustain capacitor Coled is charged with a compensation voltage to compensate the threshold voltage of the driving transistor M3.

The first node N1 is connected to the other terminal of the relay transistor M2, one terminal of the second sustain capacitor Cst, the gate electrode of the driving transistor M3, and the other terminal of the initialization transistor M5.

The organic light emitting diode OLED includes the anode connected to the other terminal of the driving transistor M3 and the cathode connected to the second power source electrode.

The switching transistor M1, the relay transistor M2, the driving transistor M3, the light emitting transistor M4, and the initialization transistor M5 may be configured as p-channel field effect transistors. In the case of p-channel field effect transistors, the gate-on voltage turning on the switching transistor M1, the relay transistor M2, the driving transistor M3, the light emitting transistor M4, and the initialization transistor M5 is a logic low level voltage, and the gate-off voltage turning the transistors off is a logic high level voltage.

The switching transistor Ml, the relay transistor M2, the driving transistor M3, the light emitting transistor M4, and the initialization transistor M5 may be n-channel field effect transistors. In the case of n-channel field effect transistors, the gate-on voltage turning on the switching transistor M1, the relay transistor M2, the driving transistor M3, the light emitting transistor M4, and the initialization transistor M5 is a logic high level voltage, and the gate-off voltage turning the transistors off is a logic low level voltage.

In the example illustrated in FIG. 2, the switching transistor M1, the relay transistor M2, the driving transistor M3, the light emitting transistor M4, and the initialization transistor M5 are n-channel field effect transistors. However at least one of the transistors may be a p-channel field effect transistor, such that the gate-on voltage for turning on the p-channel field effect transistor is a logic low level voltage and the gate-off voltage for turning off the p-channel transistor is a logic high level voltage.

The organic light emitting diode OLED may emit light corresponding to one of the primary colors. The primary colors include, for example, the three primary colors of red, green, and blue. A desired color is displayed with a spatial or temporal sum of the three primary colors. In one example, the organic light emitting diode OLED may partially emit white light, and accordingly luminance is increased. Alternatively, the organic light emitting diodes of all pixels PX may emit white light, and some of the pixels PX may further include a color filter (not shown) that changes white light emitted from the organic light emitting diodes to light of one of the primary colors.

Now, a method by which the above-described pixel is driven by a simultaneous input and light emitting method of the display device will be described.

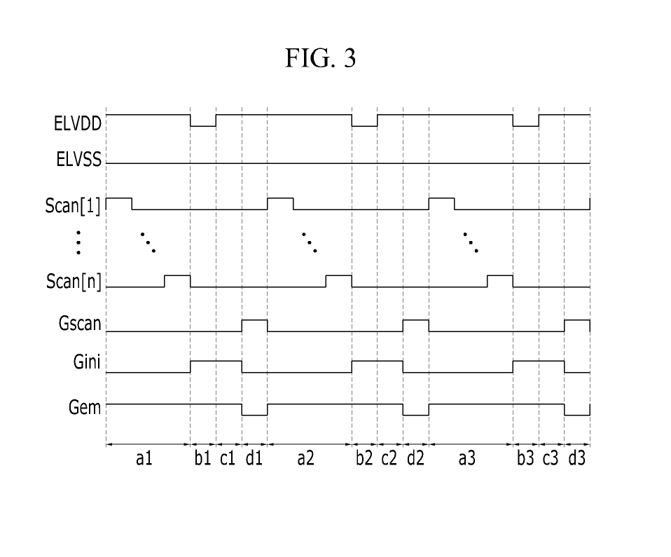

FIG. 3 is a timing diagram of a driving method of a display device according to some embodiments.

Referring to FIG. 3, the driving method of the display device according to some embodiments includes a simultaneous input and light emitting step (a), an entire pixel initialization step (b), a threshold voltage compensation step (c), and a data signal transmission step (d).

The simultaneous input and light emitting step (a) is a step in which the plurality of pixels emit light according to the image data input in the previous frame, and simultaneously the plurality of pixels are sequentially input with new image data.

The entire pixel initialization step (b) is a step for initializing the image data input to the plurality of pixels in the previous frame such that the voltage of the anode of the organic light emitting diode OLED included in the plurality of pixels is initialized.

The threshold voltage compensation step (c) is a step for compensating the threshold voltage of the driving transistor M3 such that a compensation voltage with which the threshold voltage of the driving transistor M3 is compensated is transmitted and stored to the anode of the organic light emitting diode OLED included in the plurality of pixels.

The data signal transmission step (d) is a step for transmitting the image data sequentially input to the plurality of pixels in the simultaneous input and light emitting step (a) to the driving current supply unit 12 such that light is emitted from the organic light emitting diode OLED.

In the simultaneous input and light emitting step (a), the process with which the plurality of pixels are input with the image data is sequentially executed. However, the emission of light of the plurality of pixels is simultaneously executed. Furthermore, the entire pixel initialization step (b), the threshold voltage compensation step(c), and the data signal transmission step (d) are simultaneously executed for the plurality of pixels.

Referring to FIGS. 2 and 3, the driving method of the display device according to the first power source voltage ELVDD, the second power source voltage ELVSS, the scan signals Scan[1]-Scan[n], the relay signal Gscan, the initialization signal Gini, and the light emitting signal Gem that are applied to the plurality of pixels will be described in detail.

In the first simultaneous input and light emitting period a1, the first power source voltage ELVDD and the light emitting signal Gem are applied as the logic high level voltage. The second power source voltage ELVSS, the relay signal Gscan, and the initialization signal Gini are applied as the logic low level voltage during the same time period a1. The scan signals Scan[1]-Scan[n] are sequentially applied to the plurality of scan lines as the logic high level voltage. The switching transistor M1 is turned on by the scan signals Scan[1]-Scan[n] corresponding to the logic high level voltage, and the first data signal Data1 is transmitted to the first sustain capacitor Chold through the turned-on switching transistor M1. The first data signal Data1 is stored to the first sustain capacitor Chold. Here, the relay transistor M2 is in a turned-off state, and the first data signal Data1 is not transmitted to the first node N1. On the other hand, the data signal applied in the previous frame may be stored to the second sustain capacitor Cst, and the driving transistor M3 may be in a turned-on state by the data signal stored to the second sustain capacitor Cst. As a result, the first power source voltage ELVDD is transmitted to one terminal of the driving transistor M3 through the light emitting transistor M4 that is turned on by the light emitting signal Gem. The first poser source voltage ELVDD is stored to the second sustain capacitor Cst through the driving transistor M3 such that the current corresponding to the effective data signal flows in the organic light emitting diode OLED. As a result, the organic light emitting diode OLED emits light.

That is, the plurality of pixels simultaneously emit light by the data signal applied in the previous frame in the first simultaneous input and light emitting period a1, and the plurality of pixels emitting the light are sequentially input with the first data signal Data1.

In the first entire pixel initialization period b1, the first power source voltage ELVDD is changed to the logic low level voltage, and the initialization signal Gini and the light emitting signal Gem are applied as the logic high level voltage. The second power source voltage ELVSS, the scan signals Scan[1]-Scan[n], and the relay signal Gscan are applied as the logic low level voltage. Accordingly, the light emitting transistor M4 and the initialization transistor M5 are turned on. In this example, the data line is applied with a data voltage of a degree capable of turning off the organic light emitting diode OLED, and the first power source voltage ELVDD is applied as a lower voltage than the data voltage. The anode of the organic light emitting diode OLED is initialized with a logic low level voltage that is lower than the data voltage. That is, the organic light emitting diode OLED emitting the light by the data signal applied in the previous frame in each pixel is turned off.

In the first threshold voltage compensation period c1, the first power source voltage ELVDD is changed to the logic high level voltage, and the initialization signal Gini and the light emitting signal Gem are applied as the logic high level voltage. Accordingly, the light emitting transistor M4 and the initialization transistor M5 are turned on. The second power source voltage ELVSS, the scan signals Scan[1]-Scan[n], and the relay signal Gscan are applied as the logic low level voltage. In this example, the data line is applied with a predetermined initial voltage V0 to compensate the threshold voltage Vth of the driving transistor M3. The initial voltage V0 is a voltage of a degree that does not generate current flowing in the driving transistor M3, and is capable of compensating the threshold voltage Vth of the driving transistor M3. The initial voltage V0 is transmitted to the gate electrode of the driving transistor M3 through the turned-on initialization transistor M5, and the anode of the organic light emitting diode OLED is transmitted with the compensation voltage V0-Vth corresponding to a difference between the initial voltage V0 and the threshold voltage Vth of the driving transistor M3. The compensation voltage V0-Vth is stored to the third sustain capacitor Coled.

In the first data signal transmission period d1, the relay signal Gscan is changed to the logic high level voltage, and the initialization signal Gini and the light emitting signal Gem are changed to the logic low level voltage. Accordingly, the relay transistor M2 is turned on, and the light emitting transistor M4 and the initialization transistor M5 are turned off. The first power source voltage ELVDD is applied as the logic high level voltage, and the second power source voltage ELVSS and the scan signals Scan[1]-Scan[n] are applied as the logic low level voltage. The first data signal Data1 stored to the first sustain capacitor Chold through the turned-on relay transistor M2 is transmitted and stored to the second sustain capacitor Cst as the effective data signal Veff. In this example, the size of the effective data signal Veff is variably changed according to the capacitance ratio of the first sustain capacitor Chold and the second sustain capacitor Cst. For example, if the capacitance ratio between the first sustain capacitor Chold and the second sustain capacitor Cst is 2:1, the effective data signal Veff has a size of Veff=(2*Data+V0)/3.

In the second simultaneous input and light emitting period a2, the relay signal Gscan is changed to the logic low level voltage, and the light emitting signal Gem is changed to the logic high level voltage. Accordingly, the relay transistor M2 is turned off, and the light emitting transistor M4 is turned on. The driving transistor M3 is in the turned-on state by the effective data signal Veff stored to the second sustain capacitor Cst, and the first power source voltage ELVDD is transmitted to one terminal of the driving transistor M3 through the turned-on light emitting transistor M4. The current corresponding to the effective data signal Veff is transmitted to the anode of the organic light emitting diode OLED through the driving transistor M3 such that the organic light emitting diode OLED emits light. That is, in the second simultaneous input and light emitting period a2, the plurality of pixels simultaneously emit light by the first data signal Data1. Here, a voltage Vanode of the anode of the organic light emitting diode OLED may be increased through coupling of the second sustain capacitor Cst stored with the effective data signal Veff and the third sustain capacitor Coled. For example, if the capacitance ratio between the second sustain capacitor Cst and the third sustain capacitor Coled is 1:5, the voltage Vanode of the anode of the organic light emitting diode OLED is formed with the size of Vanode=V0−Vth+(Veff−V0)/5. According to some embodiments, a gate-source voltage difference Vgs of the driving transistor M3 is Vgs=Veff−Vanode, and the current IOLED flowing in the organic light emitting diode OLED is IOLED=k(Veff−(V0+(Veff−V0)/5)².

On the other hand, in the second simultaneous input and light emitting period a2, the scan signals Scan[1]-Scan[n] of the logic high level voltage are sequentially applied to the plurality of scan lines. The switching transistor M1 of each pixel is turned on by the scan signals Scan[1]-Scan[n] of the logic high level voltage, and the second data signal Data is transmitted to the first sustain capacitor Chold through the turned-on switching transistor M1. The second data signal Data2 is stored to the first sustain capacitor Chold. That is, the second data signal Data2 is sequentially input to the plurality of pixels.

In the second entire pixel initialization period b2, the operation of the display device is executed similar to the first entire pixel initialization period b1, and the organic light emitting diode OLED of each pixel that emits the light by the first data signal Data1 is turned off.

In the second threshold voltage compensation period c2, the operation of the display device is executed similar to the first threshold voltage compensation period c1.

In the second data signal transmission period d2, the operation of the display device is executed similar to the first data signal transmission period d1, and the second data signal Data2 stored to the first sustain capacitor Chold is transmitted and stored to the second sustain capacitor Cst as the effective data signal.

In the third simultaneous input and light emitting period a3, the operation of the display device is executed similar to the first simultaneous input and light emitting period a1. The plurality of pixels simultaneously emit the light by the second data signal Data2, and the third data signal Data3 is sequentially input to the plurality of pixels during the period in which the plurality of pixels simultaneously emit the light.

As described above, the display device according to some embodiments repeatedly drives the simultaneous input and light emitting period, the entire pixel initialization period, the threshold voltage compensation period, and the data signal transmission period. As a result, the data signal may be sequentially input to the plurality of pixels during emission of light of the plurality of pixels while simultaneously emitting light from the plurality of pixels.

As described above, when the display device displays the stereoscopic image by the time-division method, the first data signal may be the first viewpoint image data, the second data signal may be the second viewpoint image data, and the third data signal may be the first viewpoint image data of the next frame. That is, the display device may sequentially input the first viewpoint image data to the plurality of pixels, and the second viewpoint image data may be sequentially input to the plurality of pixels while simultaneously light-emitting the plurality of pixels input with the first viewpoint image data. Also, the display device may input the first viewpoint image data of the next frame to the plurality of pixels while simultaneously emitting light from the plurality of pixels input with the second viewpoint image data.

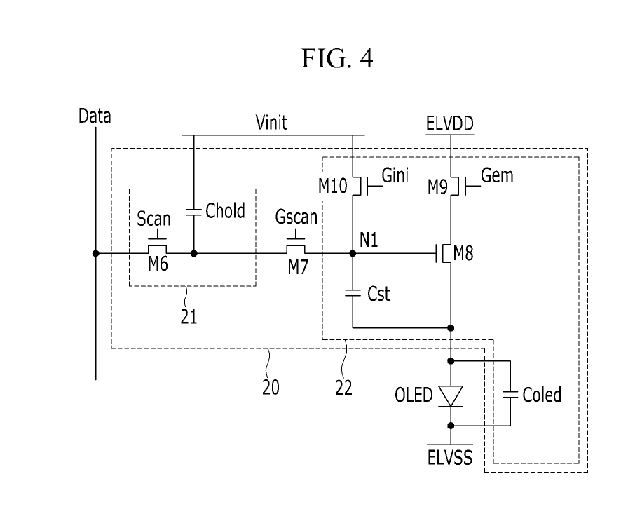

FIG. 4 is a circuit diagram of a pixel according some embodiments.

Referring to FIG. 4, the pixel includes an organic light emitting diode OLED and a pixel circuit 20 to control the organic light emitting diode OLED.

The pixel circuit 20 includes a data sustain unit 21 maintaining the data signal Data input through the data line, a driving current supply unit 22 receiving the data signal Data from the data sustain unit 21 for the light emitting of the organic light emitting diode OLED, and a relay transistor M7 transmitting the data signal Data input to the data sustain unit 21 to the driving current supply unit 22.

The sustain unit 21 includes a first sustain capacitor Chold storing the data signal Data, and a switching transistor M6 connected to the data line and transmitting the data signal Data to the first sustain capacitor Chold.

The driving current supply unit 22 includes a second sustain capacitor Cst, a driving transistor M8, a light emitting transistor M9, an initialization transistor M10, and a third sustain capacitor Coled.

Differently from the pixel circuit 10 of FIG. 2, the pixel circuit 20 of FIG. 4, one terminal of the first sustain capacitor Chold and one terminal of the initialization transistor M10 are connected to an initialization electrode having an initialization voltage Vinit.

The operation of the circuit illustrated in FIG. 4 is configured to change the initialization voltage Vinit of the initialization electrode to efficiently express the image data of a high luminance or a low luminance. Particularly, when the capacitance ratio between the first sustain capacitor Chold and the second sustain capacitor Cst is not large enough, an increase or decrease the initialization voltage Vinit is performed in order to change the voltage of the effective data signal Veff stored to the second sustain capacitor Cst.

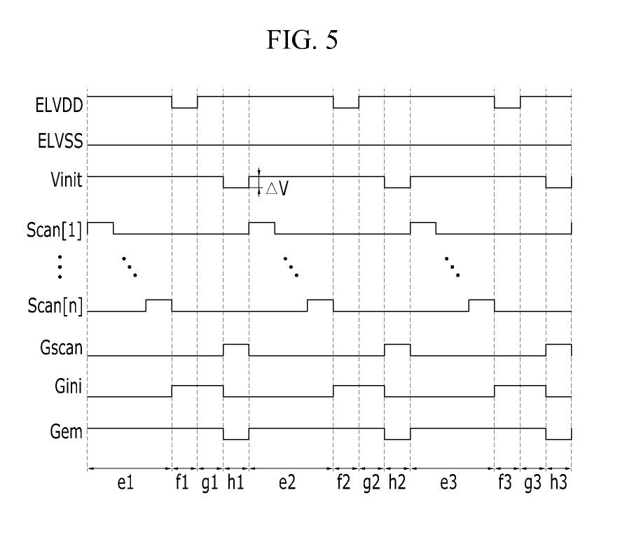

FIG. 5 is a timing diagram of a driving method of a display device according to some embodiment.

Referring to FIG. 5, a driving method of the display device including the pixel of FIG. 4 includes a simultaneous input and light emitting step E, an entire pixel initialization step f, a threshold voltage compensation step g, and a data signal transmission step h. These steps are similar to the driving method described with reference to FIG. 3 for driving the display device including the pixel of FIG. 2.

Differently from FIG. 3, the display device including the pixel of FIG. 4 increases or decreases the level of the initialization voltage Vinit by a predetermined voltage AV in data signal transmission periods h1, h2, and h3 after constantly maintaining the initialization voltage Vinit.

In the data signal transmission periods h1, h2, and h3, when the relay transistor M7 is turned on such that the data signal Data stored to the first sustain capacitor Chold is transmitted to the second sustain capacitor Cst, if the level of the initialization voltage Vinit is changed by the predetermined voltage AV, the level of the effective data signal Veff of the second sustain capacitor Cst is changed by the predetermined voltage AV through coupling of the first sustain capacitor Chold and the second sustain capacitor Cst. For example, if the capacitance ratio between the first sustain capacitor Chold and the second sustain capacitor Cst is 2:1, and the level of the initialization voltage Vinit is increased or decreased by the voltage ΔV. As a result, the effective data signal Veff of the second sustain capacitor Cst becomes Veff=(2*Data+V0)±ΔV. That is, the luminance range that may be limited by the capacitance ratio between the first sustain capacitor Chold and the second sustain capacitor Cst may be expanded by controlling the initialization voltage Vinit.

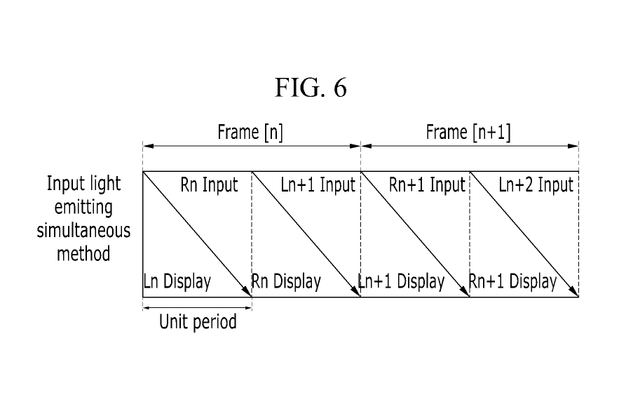

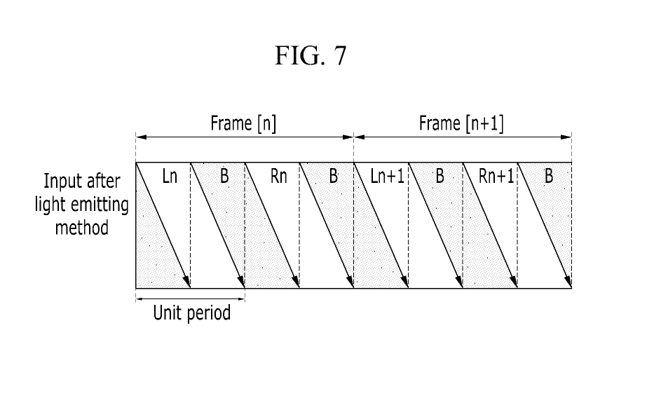

FIG. 6 is a view of a simultaneous input and light emitting method according to some embodiments. FIG. 7 is a view of one example of a method of input after light emitting.

The simultaneous input and light emitting method according to some embodiments will be described with reference to FIGS. 6 and 7 compared with the method of input after light emission.

The method of input after light emission is a method of sequentially emitting light from the plurality of pixels by sequentially inputting the left eye image data to the plurality of pixels and sequentially inputting the right eye image data to the plurality of pixels after emitting light from the plurality of pixels. According to some embodiments, a black data to divide the right and left data may be input to the plurality of pixels between the left eye image data and the right eye image data, and between the right eye image data and the left eye image data. The left-eye image may be recognized by the right eye and the right-eye image may be recognized by the left eye such that a reduction of the stereoscopic effect may be generated. However, the black data is input to prevent this reduction of the stereoscopic effect.

For example, as shown in FIG. 7, the left eye image data Ln is sequentially input to the plurality of pixels in the n-th frame and the plurality of pixels sequentially emit the light. The black data B is input to the plurality of pixels during the period in which the plurality of pixels sequentially emit the light. After the black data B is input, the right eye image data Rn is sequentially input to a plurality of pixels at a viewpoint that does not overlap the left eye image data Ln such that the plurality of pixels sequentially emit the light. The black data B is input to the plurality of pixels after the period in which the plurality of pixels sequentially emit the light. That is, in the n-th frame, the left eye image data Ln, the black data B, the right eye image data Rn, and the black data B are sequentially input to the plurality of pixels. In the (n+1)-th frame, the left eye image data Ln, the black data B, the right eye image data Rn, and the black data B are sequentially input to the plurality of pixels with the same sequence as that of the n-th frame.

As described above, four data inputs with the sequence of the first viewpoint image data, the black data, the second viewpoint image data, and the black data are executed in this method of inputting the data after light emission in one frame to display one stereoscopic image. Accordingly, the stereoscopic image display device inputs the data to the plurality of pixels with a driving speed that is faster than the 2D display device by approximately four times. For example, the image that is displayed at 60 Hz in the 2D display device is displayed at approximately 240 Hz in the stereoscopic image display device. Also, the luminance of the image may be decreased by half by the insertion of the black data in the stereoscopic image display device compared with the 2D display device. To compensate this, the stereoscopic image display device may output the image with twice the luminance such that the power consumption amount is increased.

The simultaneous input and light emitting method according to some embodiments inputs the second viewpoint image data to the plurality of pixels during the period in which the first viewpoint image data is displayed, and inputs the first viewpoint image data to the plurality of pixels during the period in which the second viewpoint image data is displayed.

For example, as shown in FIG. 6, the right eye image data Rn is sequentially input to the plurality of pixels during the period in which the left eye image data Ln is displayed in the n-th frame (Frame[n]), and the left eye image data Ln+1 of the (n+1)-th frame (Frame[n+1]) is sequentially input to the plurality of pixels during the period in which the right eye image data Rn that is input to the plurality of pixels is displayed. In Frame[n+1], the right eye image data Rn+1 is sequentially input to the plurality of pixels during the period in which the left eye image data Ln+1 is input in the previous frame (Frame[n]), and the left eye image data Ln+2 of the next frame (Frame[n+1]) is sequentially input to the plurality of pixels during the period in which the right eye image data Rn+1 is displayed.

The display device driven with the simultaneous input and light emitting method according to some embodiments does not display the black data. Instead, the display device may display the first viewpoint image data and the second viewpoint image data during most of the driving period except for the initialization step, the threshold voltage compensation step, and the data signal transmission step for all of the pixels. Accordingly, the display device driven by the simultaneous input and light emitting method may decrease the driving speed of inputting the data to the plurality of pixels compared with the display device driven by the method of input after light emission.

The period to compare the input light emitting simultaneous method and the input after light emitting method may be referred to as a unit period. While one viewpoint image data and one black data are input during the unit period in the method of input after light emission, one viewpoint image data is input during the unit period in the simultaneous input and light emitting method according to some embodiments.

For example, while the image that is displayed at 60 Hz in the 2D display device is displayed at 240 Hz in the display device driven by the method of input after light emission, the image may be displayed at 120 Hz in the display device driven by the simultaneous input and light emitting method.

Furthermore, while half of the black data is displayed during the unit period in the method of input after light emission, in the simultaneous input and light emission method the black data is not displayed and one viewpoint image data is displayed during the unit period. That is, in the display device driven by the method of input after light emission, the period in which the black data is displayed occupies half of one frame such that the luminance is decreased by half. Meanwhile, the period in which the black data is displayed is relatively small in the display device driven by the simultaneous input and light emission method such that any decrease of the luminance is small compared with the 2D display device. Accordingly, the display device driven by the simultaneous input and light emission method may display an image of the same luminance with less power consumption than the display device driven by the method of input after light emitting by half

As described above, a pixel for a display device according to some embodiments is disclosed. The pixel includes an OLED, a data sustain unit maintaining a data signal input from a data line during light emitting of the OLED, a driving current supply unit receiving the data signal from the data sustain unit to emit light from the OLED, and a relay transistor insulating the data sustain unit and the driving current supply unit from each other during the light emission of the OLED. The relay transistor is further configured to transmit the data signal input to the data sustain unit to the driving current supply unit after the OLED emits the light.

The data sustain unit may include a first sustain capacitor storing the data signal, and a switching transistor connected to the data line and configured to transmit the data signal to the first sustain capacitor.

The switching transistor may include a gate electrode applied with a scan signal including a combination of a gate-on voltage and a gate-off voltage, one terminal connected to the data line, and the other terminal connected to the first sustain capacitor.

The first sustain capacitor may include one terminal connected to a first power source electrode, and the other terminal connected to the other terminal of the switching transistor.

The first sustain capacitor may also include one terminal connected to an initialization electrode having a predetermined initialization voltage, and the other terminal connected to the other terminal of the switching transistor. The level of the data signal transmitted to the driving current supply unit from the data sustain unit is determined according to the change of the initialization voltage.

The driving current supply unit may include a second sustain capacitor storing the data signal transmitted from the data sustain unit, and a driving transistor transmitting the current corresponding to the data signal stored in the second sustain capacitor to the OLED.

The driving transistor may include: the gate electrode connected to the relay transistor, one terminal connected to the first power source electrode, and the other terminal connected to the anode of the OLED.

The second sustain capacitor may include one terminal connected to the relay transistor, and the other terminal connected to the other terminal of the driving transistor.

The driving current supply unit may further include a light emitting transistor transmitting a voltage of the first power source electrode to one terminal of the driving transistor for the current corresponding to the data signal stored to the second sustain capacitor to flow through the driving transistor.

The light emitting transistor may include a gate electrode applied with a light emitting signal including a combination of a gate-on voltage and a gate-off voltage, one terminal connected to the first power source electrode, and the other terminal connected to one terminal of the driving transistor.

The driving current supply unit may further include an initialization transistor transmitting the initialization voltage to the gate electrode of the driving transistor to initialize the OLED and to compensate the threshold voltage of the driving transistor.

The initialization transistor may include a gate electrode applied with an initialization signal including a combination of a gate-on voltage and a gate-off voltage, one terminal connected to the data line, and the other terminal connected to the gate electrode of the driving transistor.

The initialization transistor may include a gate electrode applied with an initialization signal including a combination of a gate-on voltage and a gate-off voltage, one terminal connected to an initialization electrode having a predetermined initialization voltage, and the other terminal connected to the gate electrode of the driving transistor.

The driving current supply unit may further include a third sustain capacitor including one terminal connected to the anode of the OLED and the other terminal connected to the cathode of the OLED and storing a compensation voltage compensating a threshold voltage of the driving transistor. The third sustain capacitor may be a parasitic capacitor.

According to some embodiments a display unit including a plurality of pixels is disclosed. The display unit includes a data driver applying a first data signal to the display unit and applying a second data signal to the display unit for light emitting of the plurality of pixels by a first data signal. The plurality of pixels respectively include an OLED, a driving current supply unit configured to drive the organic light emitting diode to emit light, a data sustain unit maintaining the second data signal during light emission by the OLED by the first data signal, and a relay transistor insulating the data sustain unit and the driving current supply unit from each other during the light emission by the OLED through application of the first data signal. The relay transistor may be further configured to transmit the second data signal maintained in the data sustain unit to the driving current supply unit after the OLED emits light corresponding to the first data signal.

The first data signal may correspond to a first viewpoint image data to display a stereoscopic image in one frame, and the second data signal may correspond to a second viewpoint image data to display the stereoscopic image in one frame.

A scan driver may be included and may be configured to apply the scan signal to the display unit for the first data signal and the second data signal to be sequentially input to the plurality of pixels.

The display device may further include a light emission driver applying a light emitting signal to the display unit for the plurality of pixels input with the first data signal or the second data signal to be simultaneously driven to a light emitting state.

The display device may further include a relay driver simultaneously transmitting a relay signal to transmit the second data signal maintained in the data sustain unit to the driving current supply unit to the plurality of pixels after the OLED emits the light corresponding to the first data signal.

The data sustain unit may include a first sustain capacitor storing the second data signal during the light emitting of the OLED by the first data signal, and a switching transistor transmitting the second data signal to the first sustain capacitor.

The driving current supply unit may include a second sustain capacitor storing the second data signal transmitted from the data sustain unit, and a driving transistor transmitting the current corresponding to the second data signal stored to the second sustain capacitor to the OLED.

The driving current supply unit may further include a light emitting transistor transmitting a voltage of the first power source electrode to one terminal of the driving transistor for the current corresponding to the second data signal stored to the second sustain capacitor through the driving transistor.

The driving current supply unit may further include an initialization transistor transmitting the initialization voltage to the gate electrode of the driving transistor to initialize the OLED and to compensate the threshold voltage of the driving transistor.

The driving current supply unit may further include a third sustain capacitor connected to the anode and the cathode of the OLED and configured to store the compensation voltage compensating the threshold voltage of the driving transistor. The third sustain capacitor may be a parasitic capacitor.

A method of driving a display device according to some embodiments is disclosed. The method includes sequentially inputting a first data signal to a plurality of pixels, sequentially inputting a second data signal to the plurality of pixels while simultaneously emitting light from the plurality of pixels input with the first data, and sequentially inputting a third data signal to the plurality of pixels while simultaneously emitting light from the plurality of pixels input with the second data signal.

The first data signal may correspond to a first viewpoint image data to display a stereoscopic image in one frame, and the second data signal may correspond to a second viewpoint image data to display a stereoscopic image in one frame.

The third data signal may be the first viewpoint image data to display another stereoscopic image one frame. The second data signal input to the plurality of pixels may be maintained in a data sustain unit respectively included in the plurality of pixels for the simultaneously emitting light of the plurality of pixels input with the first data signal.

The method may further include initializing the first data signal for driving the plurality of pixels to emit light after sequentially inputting the second data signal to the plurality of pixels.

The method may further include compensating the threshold voltage of the driving transistor respectively included in the plurality of pixels after initializing the first data signal for driving the plurality of pixels to emit light.

The method may further include transmitting the second data signal maintained in each data sustain unit of the plurality of pixels to the driving current supply unit light emitting the OLED respectively included in the plurality of pixels after compensating the threshold voltage of the driving transistor respectively included in the plurality of pixels.

The drawings and the detailed description described above are examples for the present invention and are provided to explain the present invention, and the scope of the present invention described in the claims is not limited thereto. Therefore, it will be appreciated to those skilled in the art that various modifications may be made and other embodiments are available. Accordingly, the scope of the present invention should be determined by the spirit and scope of the appended claims.

What is claimed is:

1. A pixel for a display device comprising:
an organic light emitting diode (OLED);
a data sustain unit configured to maintain a data signal input from a data line during light emission of the OLED;
a driving current supply unit configured to receive the data signal from the data sustain unit to emit light from the OLED; and
a relay transistor configured to insulate the data sustain unit and the driving current supply unit from each other during light emission by the OLED and transmit the data signal input to the data sustain unit to the driving current supply unit after the OLED emits the light.

2. The pixel of claim 1, wherein the data sustain unit includes:
a first sustain capacitor configured to store the data signal; and
a switching transistor connected to the data line and configured to transmit the data signal to the first sustain capacitor.

3. The pixel of claim 2, wherein the switching transistor includes:
a gate electrode coupled to a scan line applying a scan signal including a combination of a gate-on voltage and a gate-off voltage;
one terminal connected to the data line; and
the other terminal connected to the first sustain capacitor.

4. The pixel of claim 3, wherein the first sustain capacitor includes:
one terminal connected to a first power source electrode; and
the other terminal connected to the other terminal of the switching transistor.

5. The pixel of claim 3, wherein the first sustain capacitor includes:
one terminal connected to an initialization electrode having a predetermined initialization voltage; and
the other terminal connected to the other terminal of the switching transistor, wherein the level of the data signal transmitted to the driving current supply unit from the data sustain unit is determined according to a change of the initialization voltage.

6. The pixel of claim 1, wherein the driving current supply unit includes:
a second sustain capacitor configured to store the data signal transmitted from the data sustain unit; and
a driving transistor configured to transmit current corresponding to the data signal stored in the second sustain capacitor to the OLED.

7. The pixel of claim 6, wherein the driving transistor includes:
the gate electrode connected to the relay transistor;
one terminal connected to a first power source electrode; and
the other terminal connected to an anode of the OLED.

8. The pixel of claim 7, wherein the second sustain capacitor includes:
one terminal connected to the relay transistor; and
the other terminal connected to the other terminal of the driving transistor.

9. The pixel of claim 7, wherein the driving current supply unit further includes:
a light emitting transistor configured to transmit a voltage of the first power source electrode to one terminal of the driving transistor such that a current corresponding to the data signal stored to the second sustain capacitor flows through the driving transistor.

10. The pixel of claim 9, wherein the light emitting transistor includes:
a gate electrode configured to be applied with a light emitting signal including a combination of a gate-on voltage and a gate-off voltage;
one terminal connected to the first power source electrode; and
the other terminal connected to one terminal of the driving transistor.

11. The pixel of claim 7, wherein the driving current supply unit further includes:
an initialization transistor transmitting the initialization voltage to the gate electrode of the driving transistor to initialize the OLED and to compensate the threshold voltage of the driving transistor.

12. The pixel of claim 11, wherein the initialization transistor includes:
a gate electrode configured to be applied with an initialization signal including a combination of a gate-on voltage and a gate-off voltage;
one terminal connected to the data line; and
the other terminal connected to the gate electrode of the driving transistor.

13. The pixel of claim 11, wherein the initialization transistor includes:
a gate electrode applied with an initialization signal including a combination of a gate-on voltage and a gate-off voltage;
one terminal connected to an initialization electrode having a predetermined initialization voltage; and
the other terminal connected to the gate electrode of the driving transistor.

14. The pixel of claim 11, wherein the driving current supply unit further includes:
a third sustain capacitor including one terminal connected to the anode of the OLED and the other terminal connected to a cathode of the OLED, wherein the third sustain capacitor is configured to and store a compensation voltage compensating a threshold voltage of the driving transistor.

15. The pixel of claim 14, wherein the third sustain capacitor is a parasitic capacitor.

16. A display comprising:
a display unit including a plurality of pixels; and
a data driver configured to apply a first data signal to the display unit and apply a second data signal to the display unit for emitting light through the plurality of pixels by the first data signal,
wherein the plurality of pixels respectively include:
an organic light emitting diode (OLED);
a driving current supply unit configured to the OLED to emit light;
a data sustain unit configured to maintain the second data signal during light emission of the OLED by the first data signal; and
a relay transistor configured to insulate the data sustain unit and the driving current supply unit from each other during the light emission of the OLED by the first data signal and transmit the second data signal maintained in the data sustain unit to the driving current supply unit after the OLED emits light by the first data signal.

17. The display device of claim 16, wherein the first data signal corresponds to first viewpoint image data to display a stereoscopic image in one frame, and the second data signal corresponds to second viewpoint image data to display the stereoscopic image in one frame.

18. The display device of claim 16, further comprising:
a scan driver configured to apply the scan signal to the display unit for the first data signal and the second data signal to be sequentially input to the plurality of pixels.

19. The display device of claim 16, further comprising:
a light emission driver configured to apply a light emitting signal to the display unit to inputs of the plurality of pixels input with the first data signal or the second data signal to be simultaneously driven to a light emission state.

20. The display device of claim 16, further comprising:
a relay driver configured to simultaneously transmit a relay signal to transmit the second data signal maintained in the data sustain unit to the driving current supply unit to the plurality of pixels after the OLED emits light corresponding to the first data signal.

21. The display device of claim 16, wherein the data sustain unit includes:
a first sustain capacitor configured to store the second data signal during the light emission of the OLED by the first data signal; and
a switching transistor configured to transmit the second data signal to the first sustain capacitor.

22. The display device of claim 16, wherein the driving current supply unit includes:
a second sustain capacitor configured to store the second data signal transmitted from the data sustain unit; and
a driving transistor configured to transmit current corresponding to the second data signal stored to the second sustain capacitor to the OLED.

23. The display device of claim 22, wherein the driving current supply unit further includes:
a light emitting transistor configured to transmit a voltage of the first power source electrode to one terminal of the driving transistor through a current flowing through the driving transistor corresponding to the second data signal stored to the second sustain capacitor.

24. The display device of claim 22, wherein the driving current supply unit further includes:
an initialization transistor configured to transmit the initialization voltage to the gate electrode of the driving transistor to initialize the OLED and to compensate the threshold voltage of the driving transistor.

25. The display device of claim 24, wherein the driving current supply unit further includes:
a third sustain capacitor connected to an anode and a cathode of the OLED and configured to store the compensation voltage compensating the threshold voltage of the driving transistor.

26. The display device of claim 25, wherein the third sustain capacitor is a parasitic capacitor.

27. A method of driving a display device, comprising:
sequentially inputting a first data signal to a plurality of pixels;
sequentially inputting a second data signal to the plurality of pixels while simultaneously emitting light from the plurality of pixels input with the first data; and
sequentially inputting a third data signal to the plurality of pixels while simultaneously light emitting the plurality of pixels input with the second data signal.

28. The method of claim 27, wherein the first data signal corresponds to first viewpoint image data to display a stereoscopic image in one frame, and the second data signal corresponds to second viewpoint image data to display the stereoscopic image in one frame.

29. The method of claim 28, wherein the third data signal corresponds to the first viewpoint image data to display another stereoscopic image of one frame.

30. The method of claim 27, wherein the second data signal input to the plurality of pixels is maintained in a data sustain unit respectively included in the plurality of pixels for simultaneously emitting light through the plurality of pixels input with the first data signal.

31. The method of claim 30, further comprising:
initializing the first data signal for driving the plurality of pixels to emit light after sequentially inputting the second data signal to the plurality of pixels.

32. The method of claim 31, further comprising:
compensating the threshold voltage of a driving transistor respectively included in the plurality of pixels after initializing the first data signal for driving the plurality of pixels to emit light.

33. The method of claim 32, further comprising:
transmitting the second data signal maintained in each data sustain unit of the plurality of pixels to a driving current supply unit configured to emit light from the organic light emitting diode (OLED) respectively included in the plurality of pixels after compensating the threshold voltage of the driving transistor respectively included in the plurality of pixels.
